(19) United States
(12) Patent Application Publication
(10) Pub. No.: US 2011/0239962 A1
(43) Pub. Date: Oct. 6, 2011

(54) LOW SPECIFIC EMISSION DECOMPOSITION

(75) Inventors: Gregory S. Mungas, Mojave, CA (US); Jon Anthony Smith, Rancho Cordova, CA (US)

(73) Assignee: FIRESTAR ENGINEERING, LLC, Mojave, CA (US)

(21) Appl. No.: 13/079,730

(22) Filed: Apr. 4, 2011

Related U.S. Application Data
(60) Provisional application No. 61/320,673, filed on Apr. 2, 2010.

(51) Int. Cl. F02B 43/10; F02B 43/12; C10L 1/12

(52) U.S. Cl. 123/3; 44/458

(57) ABSTRACT

An alternative or supplement to combustion within an engine is decomposition of nitrous oxide into two parts nitrogen, one part oxygen. This decomposition releases thermal energy that may be captured and converted to useful work. Traditional combustion engines are limited to oxidizer/fuel ratio ratios near the proportional mixture of fuel and oxidizer that achieves complete combustion of the fuel. The presently disclosed technology increases the oxidizer/fuel ratio above that of all traditional combustion engines and still achieves useable power output primarily through decomposition of nitrous oxide. Decomposition of nitrous oxide into nitrogen and oxygen in an engine outputs two parts nitrogen and one part oxygen, which is roughly equivalent to oxygen rich atmospheric air. Output of carbon dioxide and other undesirable chemical compounds is avoided when compared to combustion of a carbon-hydrogen fuel and an oxidizer containing oxygen.

### CROSS-REFERENCE TO RELATED APPLICATIONS

The present application claims benefit of priority to U.S. Provisional Patent Application No. 61/320,673, entitled “Low Specific Emission Fuel Blends” and filed on Apr. 2, 2010, specifically incorporated by reference herein for all that it discloses or teaches.

### BACKGROUND

Combustion engines operate by combusting a fuel component with an oxidizer component. The combustion chemically changes the constituent fuel and oxidizer components to different lower energy states and thereby releases heat. For example, a typical automobile may include an internal combustion engine that combusts a gasoline or diesel fuel component with an ambient air oxidizer. Resulting heat within cylinders of the internal combustion engine are typically converted to rotational mechanical energy by allowing the gas pressure to do work on mechanical surfaces in the engine. As the gases expand through interactions with these mechanical surfaces, the gases cool and thermal energy is effectively converted into mechanical energy. This mechanical energy can be used for a number of applications including propelling a vehicle.

As automobiles and other vehicular transportation utilizing combustion engines have proliferated throughout the world, the exhaust emissions of these vehicles increasingly impact the overall quality of the atmospheric environment. In most developed countries, particularly noxious exhaust components (e.g., carbon monoxide (CO), mono-nitrogen oxides (NOₓ), mono-sulfur oxides (SOₓ), particulate matter, and unburnt hydrocarbons) are highly regulated and solutions have been developed to limit the output of those components (e.g., catalytic converters) by chemically converting those components to compounds generally considered less noxious or not noxious (e.g., carbon dioxide (CO₂), oxygen (O₂), nitrogen (N₂), and water (H₂O)).

However, carbon dioxide has now been recognized as a “greenhouse gas” (i.e., a gas in the atmosphere that absorbs and emits significant radiation within the thermal infrared range). As a result, carbon dioxide is undesirable when considering the total output of carbon dioxide in the large quantities resulting from the multitude of combustion engines that have proliferated throughout the world. Efforts to reduce or minimize the production of carbon dioxide during combustion processes have focused on increasing fuel efficiency, which as a result reduces carbon dioxide emissions. However, fuel efficiency increases are limited because the combustion process of any carbon-based fuel itself produces carbon dioxide. Other processes attempt to capture and sequester carbon dioxide in underground voids or solid carbonic salts. Sequestration, however, is very expensive, requires energy, is in many cases subject to natural disaster failures, and is still under development.

### SUMMARY

Implementations described and claimed herein address the foregoing problems by providing an engine that derives work from decomposition and combustion of a nitrous oxide fuel mixture, wherein the nitrous oxide within the mixture decomposes into a ratio of two-parts nitrogen and one-part oxygen and spent gasses from combustion and decomposition of the nitrous oxide fuel mixture include no more than 0.7 kilograms of carbon oxides per kilowatt-hour of work.

Other implementations described and claimed herein address the foregoing problems by providing a nitrous oxide fuel mixture comprising greater than nine parts of nitrous oxide for every one part of fuel by mass, wherein the nitrous oxide within the mixture is configured to decompose within an engine to a ratio of two-parts nitrogen and one-part oxygen, and release energy.

Still other implementations described and claimed herein address the foregoing problems by providing a method comprising supplying a mixture of nitrous oxide and fuel to an engine, igniting and combusting the fuel within the engine, decomposing the nitrous oxide within the engine, extracting work from the decomposing nitrous oxide and combusting fuel, and exhausting spent gasses including no more than 0.7 kilograms of carbon oxides per kilowatt-hour of work.

Other implementations are also described and recited herein.

### BRIEF DESCRIPTIONS OF THE DRAWINGS

FIG. 1 illustrates an example low emission, nitrous oxide decomposition engine operating within a standard terrestrial atmosphere chemical composition.

FIG. 2 illustrates a cross-section of an example low emission, N₂O-fuel decomposition/combustion engine on an intake stroke.

FIG. 3 illustrates a cross-section of an example low emission, N₂O-fuel decomposition/combustion engine on a power stroke.

FIG. 4 illustrates a cross-section of an example low emission, N₂O-fuel decomposition/combustion engine on an exhaust stroke.

FIG. 5 is an example graph of primary exhaust gas species from an example low emission, N₂O-fuel decomposition/combustion engine as a function of oxidizer-to-fuel (O/F) mass ratio.

FIG. 6 is an example graph of exhaust gas species from an example low emission, N₂O-fuel engine as a function of O/F mass ratio that are not normally found in the natural atmosphere in large concentration.

FIG. 7 is an example graph of specific work storage density for an example low emission, N₂O-fuel decomposition/combustion engine and N₂O-fuel storage system as a function of O/F mass ratio.

FIG. 8 is an example graph of peak gas temperature and exhaust gas temperature inside an example low emission, N₂O-fuel decomposition/combustion engine as a function of O/F mass ratio.

FIG. 9 is an example graph of specific CO₂ emissions per unit of mechanical energy output from an example low emission, N₂O-fuel decomposition/combustion engine as a function of O/F mass ratio.

FIG. 10 is an example graph of specific CO emissions per unit of mechanical energy output from an example low emission, N₂O-fuel decomposition/combustion engine as a function of O/F mass ratio.

FIG. 11 is an example graph of specific NOₓ emissions per unit of mechanical energy output from an example low emission, N₂O-fuel decomposition/combustion engine as a function of O/F mass ratio.

FIG. 12 illustrates example operations for extracting work from a N₂O-fuel mixture decomposition/combustion engine.

### DETAILED DESCRIPTIONS

The combustion engine is an engine in which the combustion of a fuel (e.g., a fossil fuel) occurs with an oxidizer (e.g., air) in a combustion chamber. In a combustion engine, the expansion of the high-temperature and high-pressure gases produced by combustion applies direct force to some component(s) of the engine, such as one or more pistons, turbine blades, or nozzles. This force moves the component(s) over a distance, generating useful mechanical energy. In some engines, the combustion is intermittent, such as four-stroke and two-stroke piston engines, along with variants, such as the Wankel rotary engine. In other engines, the combustion is continuous, such as a turbine or rocket engine or a steam engine. The presently disclosed technology may be applied to any combustion engine. Further, the presently disclosed technology may also apply to some non-combustive heat engines, such as a decomposing hydrogen peroxide rocket engine.

The fuel may include one or more of gasoline, diesel fuel, autogas, compressed natural gas, ethane, ethylene, acetylene, jet fuel, aviation fuel, fuel oil, various alcohols (e.g., enthanol, methanol, and butanol), waste peanut oil/vegetable oils, and various biofuels (e.g., biobutanol, bioenthanol, biomethanol, biodiesel, biogas), for example. Typically, the fuel will include a chemical composition of at least carbon and hydrogen components. Further, the oxidizer may include one or more of air, oxygen, nitro-methane (CH₃NO₂), nitrous oxide (N₂O), hydrogen peroxide (H₂ O₂), chlorine (Cl₂), and fluorine (F₂), for example. A typical bi-product of combustion utilizing a carbon-hydrogen fuel and an oxidizer containing oxygen is carbon dioxide, which is undesirable because it is a greenhouse gas.

An alternative or supplement to combustion within an engine is decomposition of nitrous oxide into nitrogen, oxygen, and thermal energy according to the following relationship:

2N₂O→2N₂+O₂+energy. (1)

In one implementation, the extracted energy approximately equals 81.6 MJ per kmol.

As discussed herein, an oxidizer/fuel ration (i.e., the O/F ratio) is the ratio of the mass of an oxidizer to that of a fuel in a given system. Traditional combustion engines are limited to OF ratios near a stoichiometric ratio (i.e., the proportional mixture of fuel and oxidizer that achieves complete combustion of the fuel) for the fuel and oxidizer used. The presently disclosed technology seeks to increase the O/F ratio above that of all traditional combustion engines and still achieve useable power output primarily through decomposition of nitrous oxide in addition to or rather than combustion of the fuel with the oxidizer.

Atmospheric air contains approximately 78% nitrogen, 21% oxygen, and less than 1% by volume of other gasses, including carbon dioxide. Decomposition of nitrous oxide into nitrogen and oxygen in an engine outputs two parts nitrogen and 1 part oxygen, which is roughly equivalent to oxygen-rich atmospheric air. Output of carbon dioxide and other undesirable chemical compounds is avoided when compared to combustion of a carbon-hydrogen fuel and an oxidizer containing oxygen.

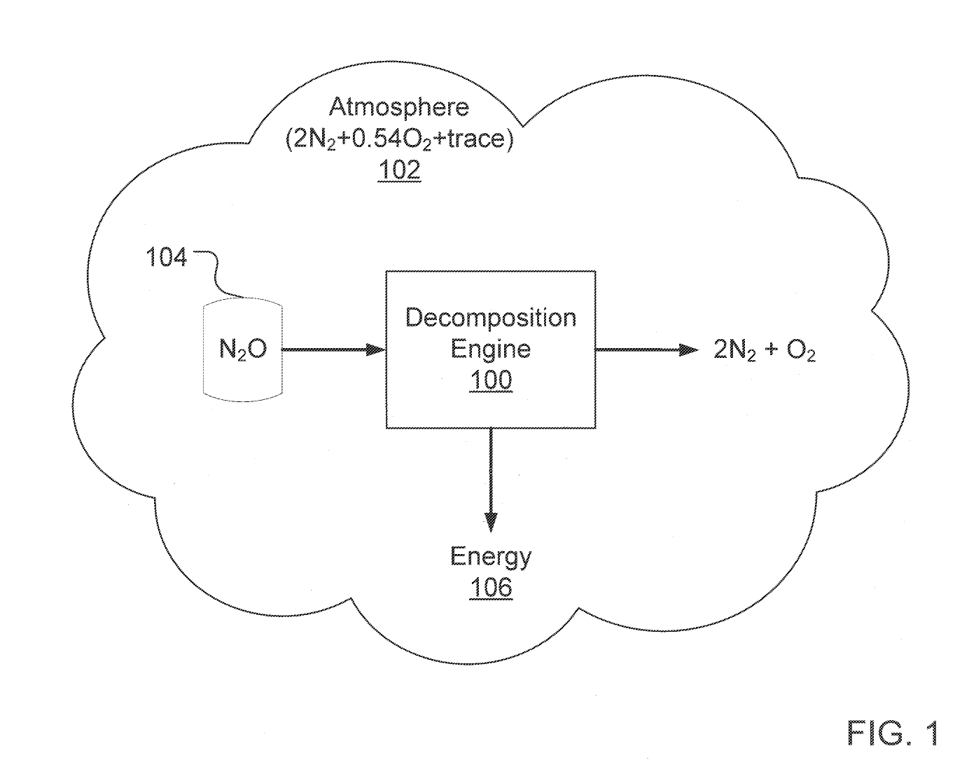

FIG. 1 illustrates an example nitrous oxide decomposition engine 100 operating within a standard terrestrial atmosphere chemical composition. As discussed above, atmospheric air 102 contains approximately two parts nitrogen, 0.54 part oxygen, and less than 1% by volume of other gasses, including carbon dioxide. The decomposition engine 100 receives nitrous oxide from a storage tank 104. The nitrous oxide within the storage tank 104 may be stored in a liquid and/or gaseous state. The decomposition engine 100 utilizes energy 106 released from the nitrous oxide when it is decomposed into nitrogen and oxygen. The energy 106 may be used to turn a shaft to propel a vehicle or power a generator, for example. The decomposition engine 100 may take a form similar to various internal or external combustion engines, as described above.

The decomposition of nitrous oxide into nitrogen and oxygen yields two parts nitrogen and one part oxygen. Since the atmospheric air 102 contains approximately two parts nitrogen, 0.54 parts oxygen, and less than 1% by volume of other gasses, the chemical composition of the decomposition engine 100 exhaust is similar (though oxygen-rich) to the atmospheric air 102. As a result, widespread use of engines such as decomposition engine 100 would have little impact on the atmosphere, aside from increasing oxygen content. Further, the decomposition engine 100 exhaust contains no chemical compounds identified as greenhouse gasses. In one implementation, energy production plants may remove nitrogen and oxygen from the air to manufacture and store energy in nitrous oxide for use in low emission, nitrous oxide decomposition engines described herein. In such an implementation, excess oxygen in the atmosphere would be removed and approximately balanced by the widespread use of low emission, nitrous oxide decomposition/combustion engines.

Nitrous oxide is chemically stable at standard atmospheric conditions. As a result, the nitrous oxide must be significantly heated and/or pressurized in order to decompose into nitrogen and oxygen and to release energy 106. In one implementation, the nitrous oxide may spontaneously decompose when compression heated to approximately 800 degrees Celsius. In another implementation, the nitrous oxide could be compressed and ignited with an ignition source. In another implementation, the nitrous oxide could be preheated by waste heat from the engine to make it easier to ignite through compression heating, spark ignition, or glow plug ignition. Many combinations of pressure, temperature, and ignition energy may be used to cause nitrous oxide to decompose within the decomposition engine 100. In one implementation, a fuel is added to the nitrous oxide to make the nitrous oxide easier to rapidly decompose. The fuel also reacts with excess oxygen from the nitrous oxide decomposition, which increases the available chemical energy for the decomposition engine 100.

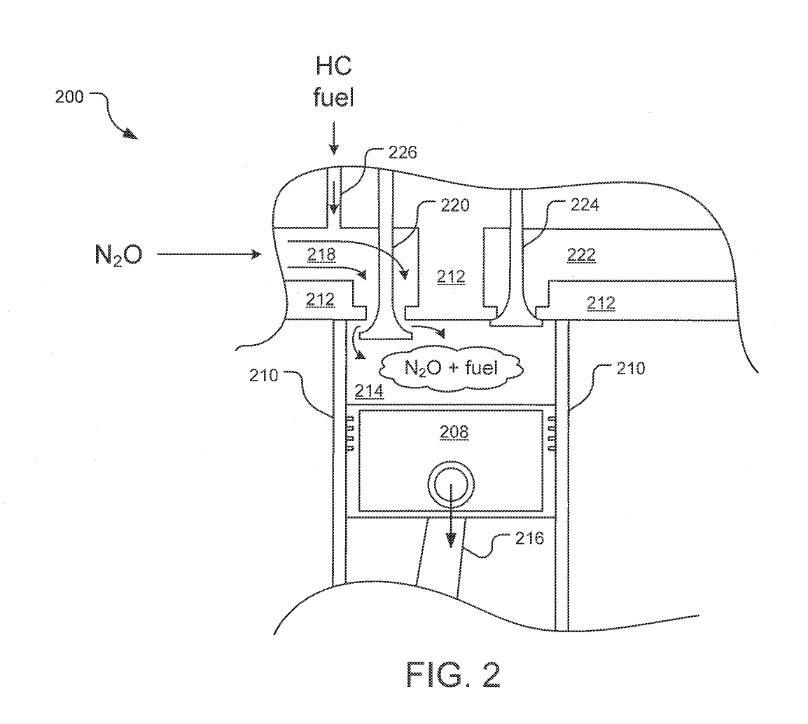

FIG. 2 illustrates a cross-section of an example low emission, N₂O-fuel decomposition/combustion engine 200 on an intake stroke. The engine 200 includes a decomposition/combustion chamber 214 bounded by a piston 208 at the bottom, a cylinder 210 at the sides, and a cylinder head 212 at the top of the chamber 214. The piston 208 is configured to reciprocate within the cylinder 210 and connect to a crankshaft (not shown) via a connecting rod 216. Reciprocation of the piston 208 creates rotation of the crankshaft to produce work.

The engine 200 also includes an intake port 218 with a corresponding intake valve 220 and an exhaust port 222 with a corresponding exhaust valve 224. Since the piston 208 is depicted during the intake stroke, the intake valve 220 is open (i.e., extended away from the cylinder head 212) and the exhaust valve 224 is closed (i.e., seated against the cylinder head 212). Further, the piston 208 is moving away from the cylinder head 212, expanding the chamber 214. Nitrous oxide enters the chamber 214 through the intake port 218 and the open intake valve 220. Further, the engine 200 includes a fuel intake port 226. The fuel intake port 226 may inject fuel into the intake port 218, as shown. In another implementation, the fuel intake port 226 may inject fuel directly into the cylinder 210. In yet another implementation, the intake port 226 may inject nitrous oxide and fuel. In still another implementation, the intake port 218 may be used to inject fuel into the engine and the fuel intake port 226 can be used to directly inject nitrous oxide into the engine.

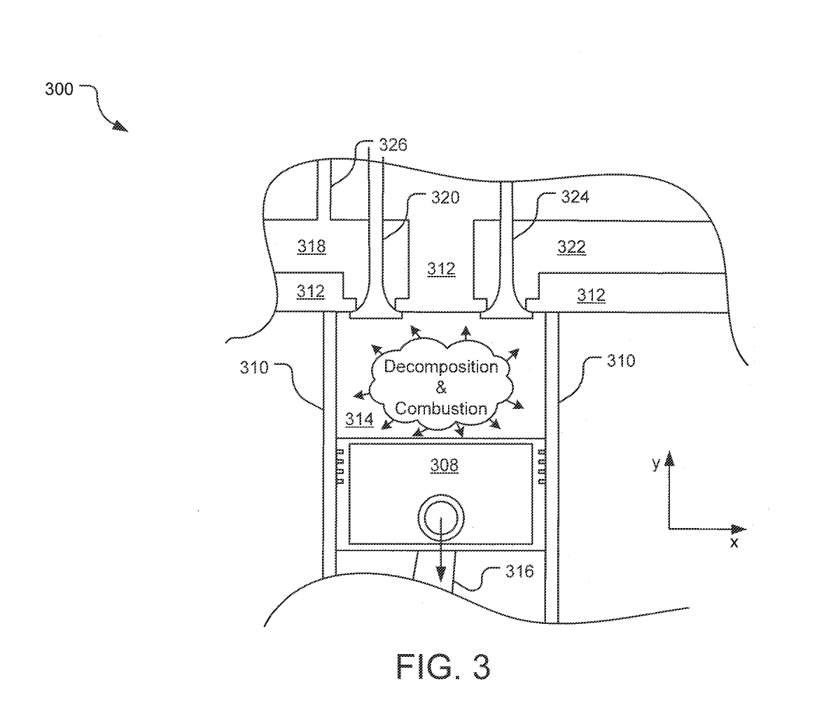

Nitrous oxide is stored at high vapor pressures. For example, around room temperature (i.e., approximately 20 to 29 degrees Celsius) the vapor pressure of nitrous oxide is greater than 500 psia. Because nitrous oxide is stored under relatively high pressures, in some implementations, the nitrous oxide can be directly injected into the engine 200 without requiring a separate compression stroke to increase the density of nitrous oxide immediately prior to a power stroke (see FIG. 3). Similarly, high vapor pressure fuels such as natural gas, ethane, ethylene, may be used to avoid a separate compression stroke. Compression strokes and pumps rob mechanical energy from an engine, and therefore it may be desirable to avoid compressing the nitrous oxide and fuel charge prior to a power stroke. Other low vapor pressure fuels may be pre-pressurized with a pump prior to injection into an engine.

In a bipropellant combustion/decomposition engine, the fuel and the nitrous oxide are kept separate until the point of ignition where the fuel and oxidizer are mixed together for combustion in the combustion chamber as depicted in FIG. 2. In a monopropellant combustion/decomposition engine (not shown), the fuel and the nitrous oxide pre-mixed and then be moved to the point of ignition for combustion in the combustion chamber. The presently disclosed technology may be applied to both bipropellant and monopropellant engines.

FIG. 3 illustrates a cross-section of an example low emission, N₂O-fuel decomposition/combustion engine 300 on a power stroke. The engine 300 includes a decomposition/combustion chamber 314 bounded by a piston 308 at the bottom, a cylinder 310 at the sides, and a cylinder head 312 at the top of the chamber 314. The piston 308 is configured to reciprocate within the cylinder 310 and connect to a crankshaft (not shown) via a connecting rod 316. Reciprocation of the piston 308 creates rotation of the crankshaft to produce work.

The engine 300 also includes an intake port 318 with a corresponding intake valve 320 and an exhaust port 322 with a corresponding exhaust valve 324. Since the piston 308 is depicted during the power stroke, both the intake valve 320 and the exhaust valve 324 are closed (i.e., seated against the cylinder head 312). Further, the piston 308 is moving away from the cylinder head 312, in response to high pressures caused by decomposition and combustion of a nitrous oxide—fuel charge within the chamber 314. The high pressures push on the piston and allow extraction of thermal energy from the expanding and cooling gas.

The nitrous oxide, once within the chamber 314 is heated, pressurized, and/or ignited to trigger decomposition of the nitrous oxide. For example, the chamber 314 may be extremely hot and thermally conductive, thus rapidly heating the nitrous oxide once it enters the chamber 314. Also, a compression stroke (not shown) of the engine 300 may be included to compress the nitrous oxide within the chamber 314 before the power stroke of FIG. 3. Further, the engine 300 may include a spark plug, glow plug, or other ignition source (not shown) within the chamber 314 to further aid in initiating decomposition of the nitrous oxide. The decomposition of the nitrous oxide causes rapid build-up of pressure in the chamber 314, providing a large downward force on the piston 308. Decomposition of nitrous oxide within the engine 300 to produce useful work may be accomplished using a two, three, four, or more stroke engine cycle, as per the intended application.

Further, the engine 300 includes a fuel intake port 326 to allow the nitrous oxide and fuel to mix. Utilization of fuel in the engine 300 creates combustion of the fuel as well as decomposition of the nitrous oxide in the chamber 314. The combustion of the fuel may aid in achieving the temperature, pressure, and/or ignition that triggers decomposition of the nitrous oxide. In one implementation, the aforementioned spark plug, glow plug, or other ignition source may be used to trigger combustion of the fuel within the chamber 314. The combustion then increases the temperature and/or pressure within the chamber 314 sufficient to trigger decomposition of the nitrous oxide. In implementations utilizing fuel, the nitrous oxide to fuel ratio is specified so that carbon dioxide, carbon monoxide, water, and other emissions (e.g., NOx emissions) are minimized. In other implementations, the engine 300 does not include a fuel intake port and relies solely on decomposition of nitrous oxide to provide power. The intake nad exhaust structures for getting nitrous oxide and fuel into the combustion chamber 314 and spent gasses out of the combustion chamber 314 are for illustration purposes only. Other configurations to allow direct injection of either or both nitrous oxide and fuel into the combustion chamber 314 are contemplated herein.

The extremely high temperatures necessary to trigger decomposition of the nitrous oxide may benefit from insulative materials surrounding the chamber 314 that can withstand and contain heat within the chamber 314. For example, an insulative piston provides thermal resistance to heat flow from the chamber 314 propagating in the negative y-direction, an insulative cylinder provides thermal resistance in directions perpendicular to the y-axis extending away from the chamber 314, and an insulative cylinder head provides thermal resistance in the positive y-direction. Various applications of engines may utilize one or more of the insulative piston, the insulative cylinder, and the insulative cylinder head. In an implementation utilizing all of the insulative piston, the insulative cylinder, and the insulative cylinder head, the chamber 314 is insulated in all directions, allowing the chamber 314 to reach the very high operating temperatures for decomposition of nitrous oxide.

Highly insulative materials may also be highly porous. As a result, the highly insulative material of the piston, cylinder, and/or cylinder head adjacent the chamber 314 may be coated with a low-porosity sealing structure so that chemical components within the chamber 314 are prevented from permeating into the piston, cylinder, and/or cylinder head. Still further, the chemical components within the chamber 314 may be highly reactive with the insulative material and/or low-porosity sealing structure. As a result, the piston, cylinder, and/or cylinder head adjacent the chamber 314 may further include a low-reactivity coating.

For example, the piston, cylinder, and/or cylinder head includes a mass of high-porosity insulative material (e.g., carbon foam, high-porosity silicon carbide foam) surrounded by a low-porosity sealing structure (e.g., metal and/or ceramic oxides (e.g. aluminum oxide, magnesium oxide, zirconium oxide), carbon fibre-reinforced carbon, pyrolytic graphite, low porosity silicon carbide, various refractory metals, tantalum, niobium, tungsten, rhenium, molybdenum, cordierite, and alumina zirconium oxide). The piston, cylinder, and/or cylinder head may also include a low-reactivity coating (e.g., oxidation resistant refractory metals, iridium or iridium/rhenium eutectic mixtures, hafnium carbide, metal oxide chemical vapors, and/or silicon carbide. The coating may also include two or more layers of one or more of the aforementioned materials. Other materials may be used for the insulative material, the sealing structure, and/or the coating that possess the structural, insulative, permeability, and reactivity properties desired for the insulative material, the sealing structure, and/or the coating.

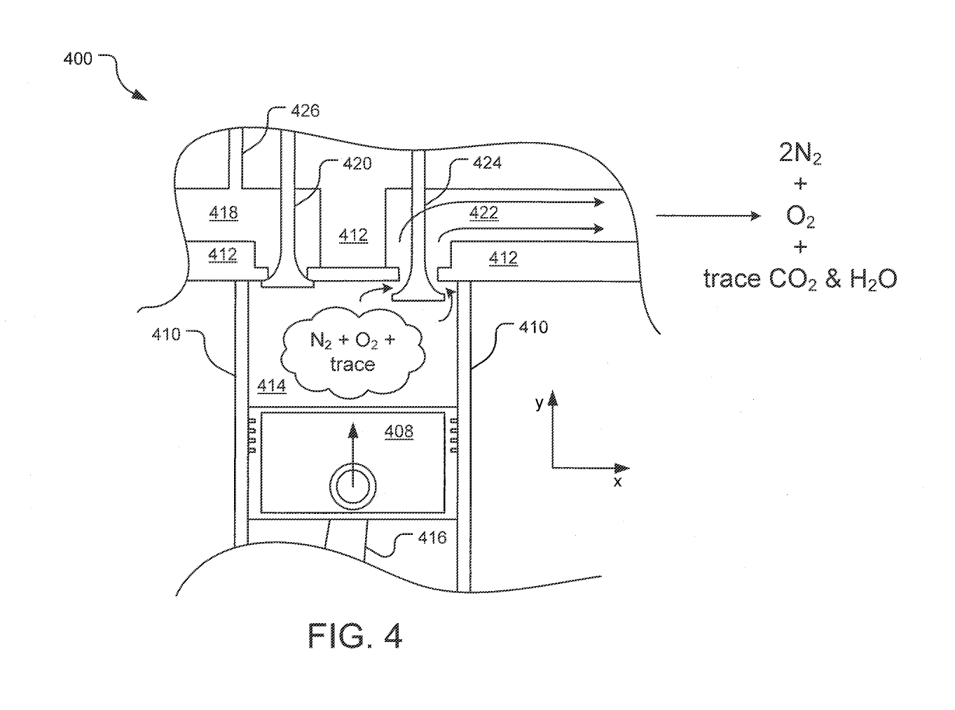

FIG. 4 illustrates a cross-section of an example decomposition/combustion engine 400 on an exhaust stroke. The engine 400 includes a decomposition/combustion chamber 414 bounded by a piston 408 at the bottom, a cylinder 410 at the sides, and a cylinder head 412 at the top of the chamber 414. The piston 408 is configured to reciprocate within the cylinder 410 and connect to a crankshaft (not shown) via a connecting rod 416. Reciprocation of the piston 408 creates rotation of the crankshaft to produce rotary shaft work.

The engine 400 also includes an intake port 418 with a corresponding intake valve 420 and an exhaust port 422 with a corresponding exhaust valve 424. Since the piston 408 is depicted during the exhaust stroke, the intake valve 420 is closed (i.e., seated against the cylinder head 412) and the exhaust valve 424 is open (i.e., extended away from the cylinder head 412). Further, the piston 408 is moving toward from the cylinder head 412, decreasing the volume of the chamber 414. Two parts nitrogen and one part oxygen formed from decomposition of nitrous oxide is allowed to exit the chamber 414 through the exhaust port 422 and the open exhaust valve 424. Decomposition of nitrous oxide within the engine 400 to produce useful work may be accomplished using a two, three, four, or more stroke engine cycle, as per the intended application.

Further, the engine 400 includes a fuel intake port 426. Utilization of fuel in the engine 400 creates combustion of the fuel as well as decomposition of the nitrous oxide in the chamber 414. The combustion of the fuel may aid in achieving the temperature, pressure, and/or ignition that triggers decomposition of the nitrous oxide. In implementations utilizing fuel, the nitrous oxide to fuel ratio is specified such that carbon dioxide, carbon monoxide, and other emissions such as nitrogen-oxygen (NOx) compounds are minimized. In other implementations, the engine 400 does not include a fuel intake port and relies solely on decomposition of nitrous oxide to provide power.

The extremely high temperatures necessary to trigger decomposition of the nitrous oxide may benefit from insulative materials surrounding the chamber 314 that can withstand and contain heat within the chamber 314. Various applications of engines may utilize one or more of the insulative piston, the insulative cylinder, and the insulative cylinder head. In an implementation utilizing all of the insulative piston, the insulative cylinder, and the insulative cylinder head, the chamber 314 is insulated in all directions, allowing the chamber 314 to reach the very high operating temperatures for decomposition of nitrous oxide.

Often highly insulative materials are also highly porous. As a result, the highly insulative material of the piston, cylinder, and/or cylinder head adjacent the chamber 314 may be coated with a low-porosity sealing structure so that chemical components within the chamber 314 are prevented from permeating into the piston, cylinder, and/or cylinder head. Still further, the chemical components within the chamber 314 may be highly reactive with the insulative material and/or low-porosity sealing structure. As a result, the piston, cylinder, and/or cylinder head adjacent the chamber 314 may further include a low-reactivity coating.

As discussed above, traditional combustion engines are limited to O/F ratios near or below (i.e., fuel-rich) a stoichiometric ratio (i.e., the proportional mixture of fuel and oxidizer that achieves complete combustion of the fuel) for the fuel and oxidizer used. The presently disclosed technology seeks an O/F ratio above that of all traditional combustion engines and still achieve useable power output primarily through decomposition of nitrous oxide in addition to or rather than combustion of the fuel with the oxidizer.

A first-order cycle analysis of an example low emission, N₂O-fuel decomposition/combustion engine cycle follows based on the following assumptions. The N₂O-fuel cycle is a two-stroke cycle with a power stroke and exhaust stroke. N₂O-fuel is assumed to be rapidly injected near top-dead-center (TDC) into a cylinder of a reciprocating cylinder engine. The N₂O-fuel is injected at a density that when combusted under constant volume conditions (simulating very rapid combustion kinetics), the maximum cylinder pressure (without any heat loss) is 3000 psia. Rapid combustion is a good assumption because nitrous oxide/fuel mixtures have rapid kinetics relative to movement of the piston. This analysis also assumes a well-insulated chamber for combustion and decomposition, which establishes an upper bound on the available chemical energy that can be converted into useful work. The calculated work from this cycle assumes an isentropic (no mechanical or heat losses) expansion down to 1 bar of pressure (slightly over standard atmospheric pressure) during the power expansion stroke. The exhaust stroke is assumed to have negligible compression losses that would cause a reduction in the net work out of the cycle. The gas chemistry at the exhaust gas port is assumed to be under chemical equilibrium conditions associated with the 1 bar pressure and exhaust gas temperature going through the expansion stroke defined above.

Based on the assumptions above, to estimate specific work and exhaust gas emission chemistry for a given O/F ratio of an N₂O-ethylene mixture, an initial estimated N₂O-fuel density is loaded into a Chemical Equilibrium Analysis (CEA) code. CEA is used to predict constant volume combustion pressure, temperature, and entropy. This process is iterated until a N₂O-fuel density is found that produces a peak cylinder pressure of 3000 psia. To simulate the power stroke expansion process, this combustion chemistry is then loaded into CEA at the same entropy as the post-combustion process, but at only 1 bar pressure simulating the exhaust gas pressure. The chemistry and temperature at this exhaust state are recorded. The specific work extracted is the difference in internal energy of the exhaust gases compared to the injected N₂O-fuel charge. Work losses due to compression with the exhaust valve open are assumed negligible.

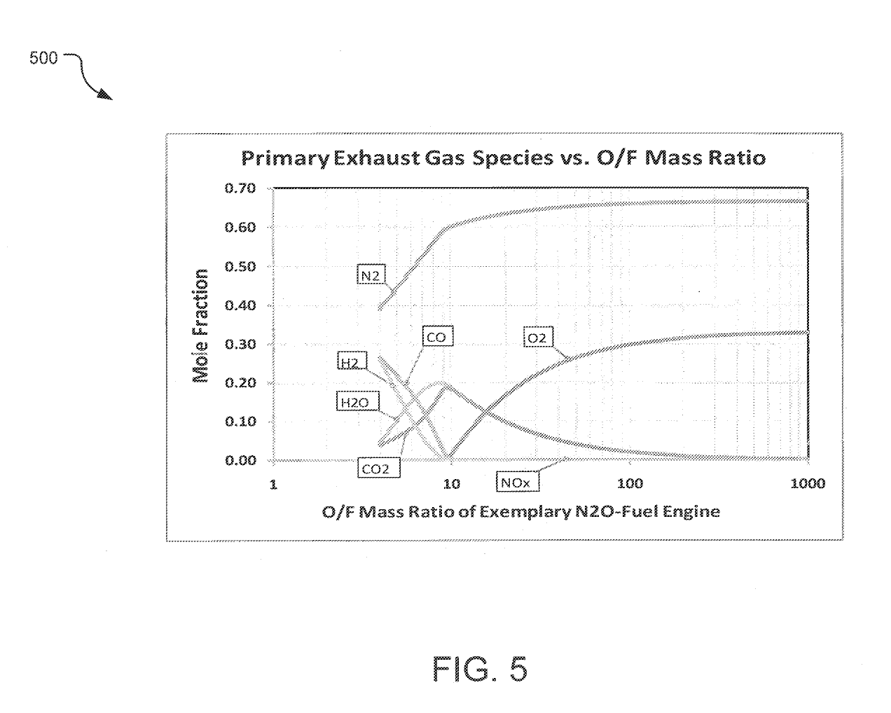

FIG. 5 is an example graph 500 of primary exhaust gas species from an example low emission, N₂O-fuel decomposition/combustion engine as a function of oxidizer-to-fuel (O/F) mass ratio. FIG. 5 incorporates the assumptions and analysis described above. FIG. 5 illustrates all of the primary exhaust gas species that are produced from the N2O-ethylene engine described above. Above an O/F ratio of approximately 10:1, carbon dioxide emissions rapidly decrease while nitrogen and oxygen emissions increase.

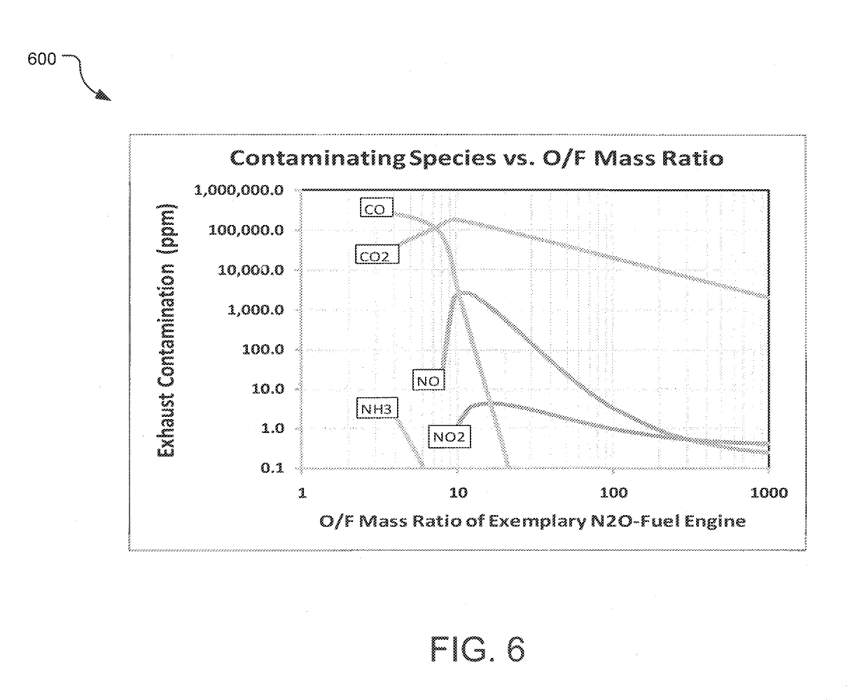

FIG. 6 is an example graph 600 of exhaust gas species from an example low emission, N₂O-fuel engine as a function of O/F mass ratio that are not normally found in the natural atmosphere in large concentration. These exhaust gas species are considered contaminants or undesirable chemical species to be added to the atmosphere in mass quantities. CO₂, for example, while naturally occurring, is a greenhouse gas. Attempts are being made to significantly reduce the concentrations of release of this major exhaust gas species into the atmosphere. Above an O/F ratio of approximately 10:1 (approximately 15:1 for NO₂), all of the contaminating species emissions decrease rapidly.

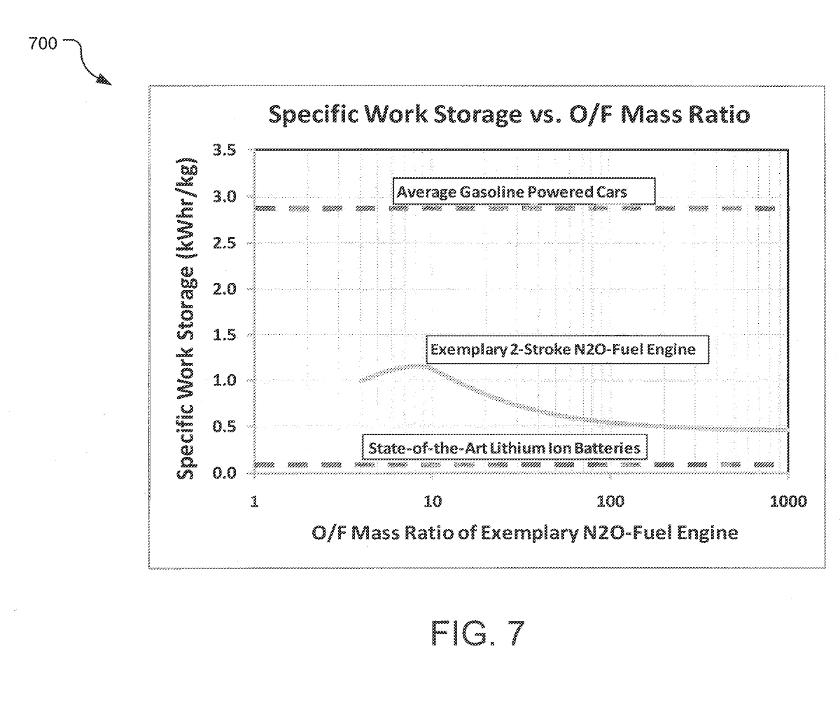

FIG. 7 is an example graph 700 of specific work storage density for an example low emission, N₂O-fuel decomposition/combustion engine and N₂O-fuel storage system as a function of O/F mass ratio. The specific work storage density is the mechanical work extracted from an example N₂O-ethylene energy storage system divided by the mass of the N₂O-ethylene energy storage medium. The exemplary N₂O-fuel specific work storage density is compared to lithium ion battery cells (assuming a 145 Whr/kg energy storage capacity and 90% conversion efficiency) and more traditional gasoline powered car engines (assuming 45 MJ/kg of raw energy storage in the fuel and a 22% conversion efficiency). The specific work storage density of the N₂O-fuel decomposition/combustion engine lies between the lithium ion battery cells and the traditional gasoline powered car engine.

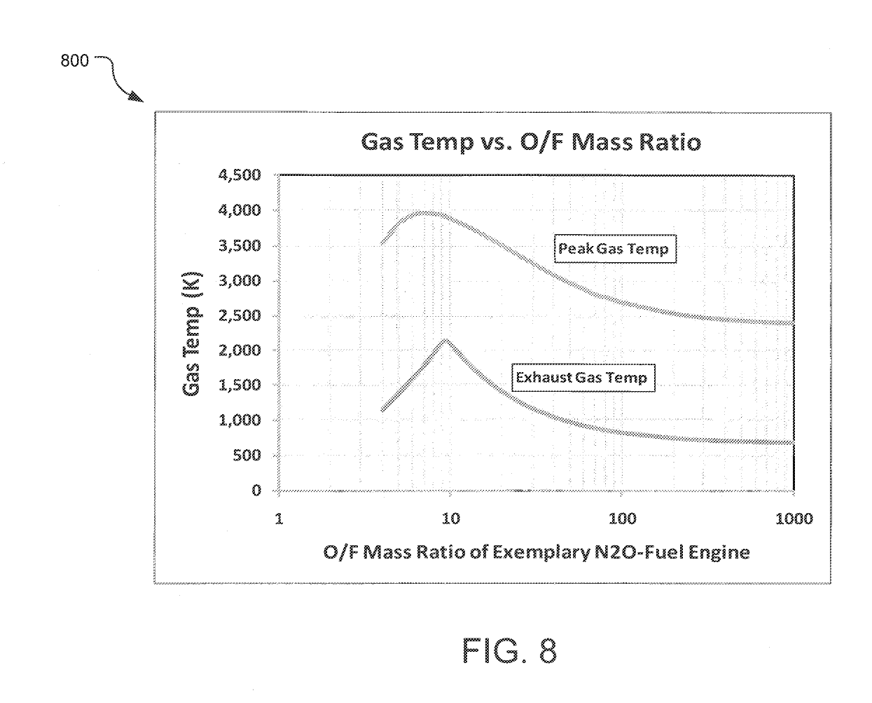

FIG. 8 is an example graph 800 of peak gas temperature and exhaust gas temperature inside an example low emission, N₂O-fuel decomposition/combustion engine as a function of O/F mass ratio. The graph 800 applies after combustion of a nitrous oxide/fuel working fluid and after expansion of the working fluid down to 1 bar (approximately 1 atm) as a function of O/F ratio. The peak combustion gas temperature of ˜3970K occurs at an O/F of approximately 7. The peak exhaust gas temperature of approximately 2140K occurs at an O/F of approximately 9.5. These temperatures in combination with the associated chemistry identified above influence the thermal design of the engine that would contain the hot combustion gases in a combustion cylinder or equivalent and the exhaust system.

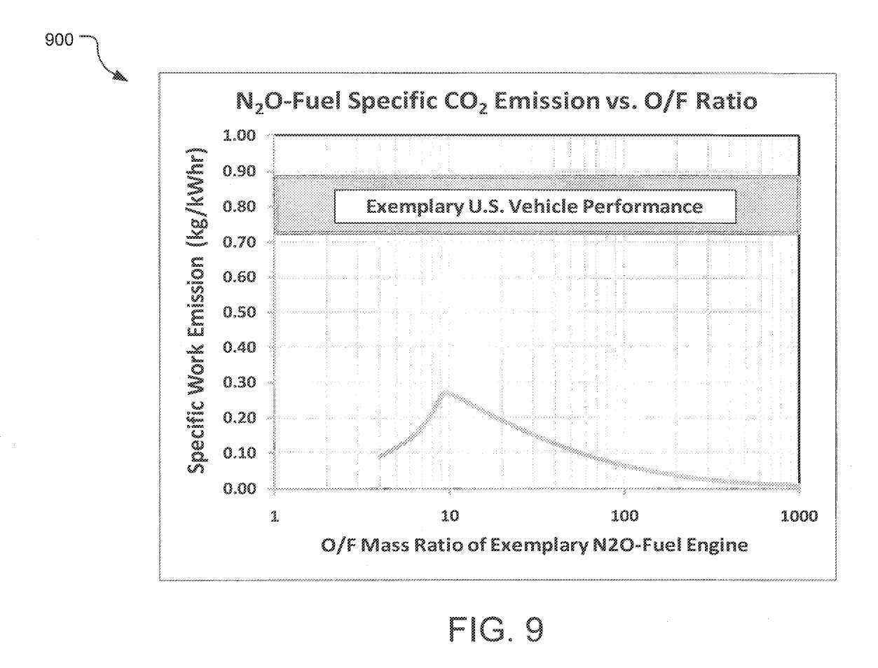

FIG. 9 is an example graph 900 of specific CO₂ emissions per unit of mechanical energy output from an example low emission, N₂O-fuel decomposition/combustion engine as a function of O/F mass ratio. Graph 900 applies to the N₂O-fuel cycle described above. At an O/F mass ratio of approximately 9.5:1, the specific work emission of carbon dioxide equals approximately 0.27 kg CO2/kW·hr. These specific carbon dioxide emission numbers compare favorably with even the most efficient air/hydrocarbon combustors, which range from the most highly efficient house-sized marine diesel engines at approximately 0.505 kg CO2/kW·hr, typical gasoline automobile engines typically between approximately 0.72 and 0.89 kg CO2/kW·hr, to modern turboprop aircraft with as high as 1.7 kg CO2/kW·hr.

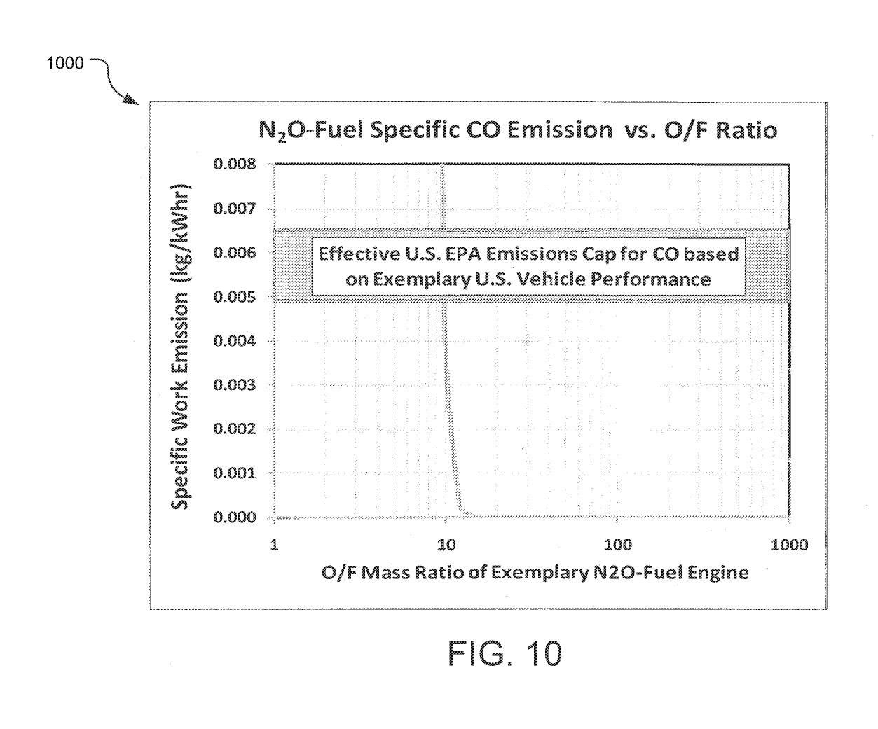

FIG. 10 is an example graph 1000 of the specific CO emissions per unit of mechanical energy output from an example low emission, N₂O-fuel decomposition/combustion engine as a function of O/F mass ratio. Graph 1000 applies to the N₂O-fuel cycle described above. At O/F ratios below 10, the carbon monoxide specific emissions increase rapidly for this example N₂O-fuel cycle and may quickly exceed a U.S. EPA emissions cap for CO (at approximately 0.005 kg CO/kW·hr).

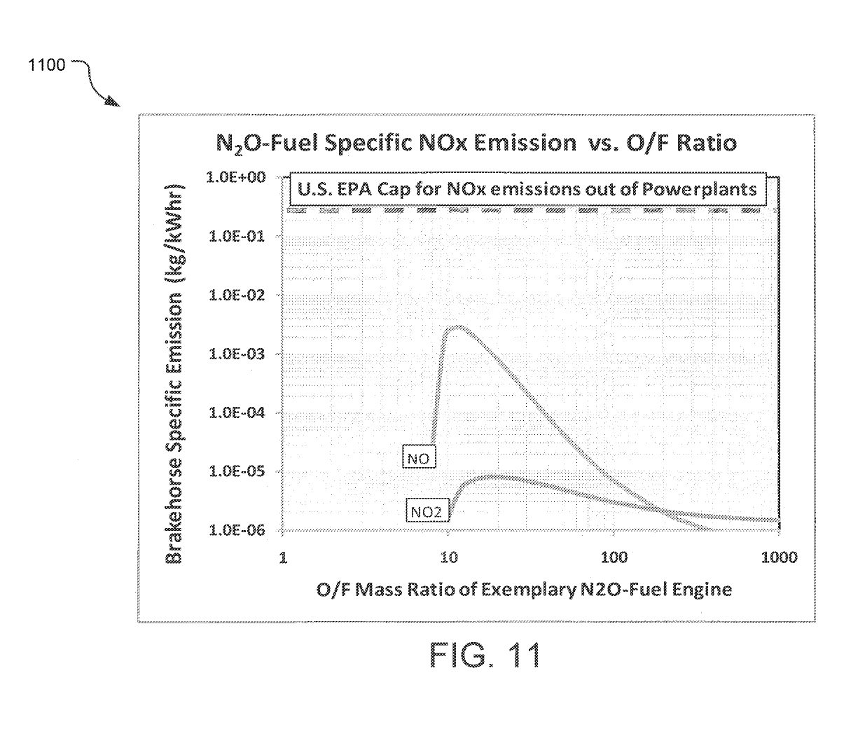

FIG. 11 is an example graph 1100 of specific NOₓ emissions per unit of mechanical energy output from an example low emission, N₂O-fuel decomposition/combustion engine as a function of O/F mass ratio. Graph 1100 applies to the N₂O-fuel cycle described above. For this cycle, peak NOₓ emissions occur from O/F ratios of about 9 to about 30. Higher NOₓ emissions could occur if the combustion gas kinetics do not allow NOₓ formed in the engine to fully equilibrate. Although the NOₓ emissions shown in FIG. 11 are low relative to U.S. EPA caps as identified in FIG. 11, real NOₓ emissions could be higher. These higher NOₓ emissions if considerably higher than those shown in FIG. 11 could be addressed using similar mechanisms used to control NOₓ emissions in standard hydrocarbon-air engines (e.g., catalytic converters, ingestion of air into exhaust, etc.).

Although the analysis conducted above was for utilizing ethylene as the fuel, very similar results are obtained utilizing different fuels previously identified and other hydrocarbon fuels. Further, although the analysis conducted above was for an example two-stroke engine configuration, similar thermodynamic cycle analysis can be conducted to determine specific work and emission characteristics of other cycles.

In one example implementation, nitrous oxide/fuel mixtures as described herein below 10:1 OF ratio are appropriate for applications that have limited tank storage volume or mass or for which emissions output, particularly carbon monoxide are of less concern than the energy density produced per unit mass of nitrous oxide and fuel.

However, higher O/F mass ratios produce substantial amount of energy with very low fuel consumption and very low specific carbon dioxide and carbon monoxide emission. The energy produced comes primarily from the nitrous oxide chemistry, wherein the fuel acts primarily to effectively reduce the activation energy of the nitrous oxide decomposition and speed up the combustion kinetics.

Referring back to FIG. 7, near OF ratios of 1000, the energy density of the nitrous oxide/fuel combination mixture asymptotically approaches that of pure nitrous oxide decomposition. The raw chemical energy from N₂O thermal decomposition is about 1.9 MJ/kg. As a result, in some implementations, nitrous oxide/fuel mixtures that are as lean in fuel as possible substantially reduces carbon monoxide and carbon dioxide production. In many implementations, the lean limit to the nitrous oxide/fuel mixture is the temperature and pressure limit of the engine extracting energy from the nitrous oxide/fuel mixture. The higher the pressure ratio that the engine can handle, the larger fraction of the raw chemical energy that can be extracted by the engine. In an example implementation, thermodynamically, the carbon monoxide and carbon dioxide production will be on the order of 1×10⁻⁵⁰ kg CO/kW·hr and 5×10⁻⁶ kg CO₂/kW·hr, respectively.

In another implementation, nitric oxide formation is limited during its initial production. This may be accomplished by reducing the temperature at which the engine operates. Because the described nitrous oxide/fuel engine functions without an external oxidizer (e.g., air as do current O₂/fuel combustors), an inert gas may be sued to reduce the combustion temperature. For example, water (H₂O) may be used as it both lowers the temperature to limit nitric oxide production and when heated is itself an excellent working fluid. Incorporating liquid water with a nitrous oxide fuel mixture lowers the peak combustion gas temperature of a nitrous oxide fuel mixture due to the energy associated with vaporizing the water and flashing it into steam. Because of the high density of liquid water immediately prior to combustion compared to the very low density of steam, despite the decrease in combustion gas temperature, the decay in cylinder pressure inside the engine falls off mildly. This is a well-known mechanism utilized in internal combustion engines to lower the peak combustion gas temperatures without losing too much cylinder pressure and corresponding power output. In the low emission, nitrous-fuel decomposition/combustion engines, this same technique will allow the engines to operate at significantly lower temperatures with more modest decay in fuel economy. The lower combustion gas temperatures will aid in engine design and having more options for materials that can survive inside the low emission, nitrous-fuel decomposition/combustion engine environment. For example, a nitrous oxide fuel blend may include less than thirty parts of water for every one hundred parts of nitrous oxide by mass.

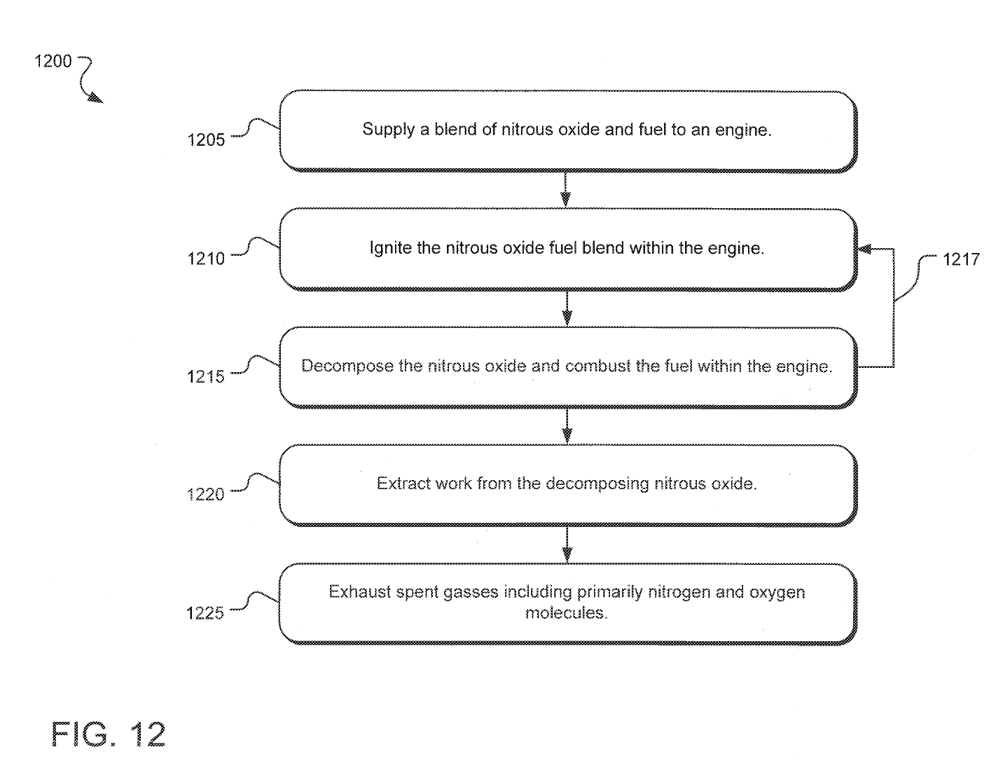

FIG. 12 illustrates example operations 1200 for extracting work from a nitrous oxide fuel mixture decomposition engine. A supplying operation 1205 supplies a mixture of nitrous oxide and fuel to an engine. The ratio of nitrous oxide to fuel may range from pure nitrous oxide down to 10:1. In some special applications, where carbon monoxide emission is not of a concern, the lower limit on O/F mass ratio could be as low as 4:1. Further, the nitrous oxide and fuel may be stored separately in containers and injected separately into the engine. Further, the nitrous oxide and fuel may be mixed just prior to injection into the engine. Still further, the nitrous oxide and fuel may be premixed into a monopropellant and stored in one tank. The engine may be patterned after any known combustion engine configuration (e.g., a reciprocating piston internal combustion engine). In a reciprocating piston internal combustion engine application, the nitrous oxide and fuel is supplied to a combustion chamber within the engine. The fuel may be a hydrocarbon.

An ignition operation 1210 ignites the nitrous oxide fuel mixture within the engine. Ignition could be electrical ignition or by heating to an auto-ignition temperature. Example ignition mechanisms include without limitation use of spark plugs, use of glow plugs, use of gas compression, use of preheating of the propellant prior or during injection, and/or any combination of these or similar methods. Combustion of the fuel causes a rise in temperature and pressure within the engine (or combustion chamber in the reciprocating piston internal combustion engine application).

A decomposing/combusting operation 1215 decomposes the nitrous oxide within the engine and combusts the fuel within the engine. The increased temperature and pressure cased by ignition operation 1210 may be a catalyst for the decomposing/combusting 1215. The nitrous oxide decomposes into two parts nitrogen molecules (or atoms) and one part oxygen molecules (or atoms). The oxygen molecules may operate to combust additional fuel within the decomposing working fluid, as illustrated by arrow 1217 returning to operation 1210. Further decomposition of the nitrous oxide releases energy. In the reciprocating piston internal combustion engine application, the released energy is converted to additional pressure and temperature within the combustion chamber.

An extraction operation 1220 extracts work from the decomposition/combustion reaction by utilizing the pressure contained in the decomposition/combustion gases relative to an outlet state to extract thermal and chemical energy from the decomposition/combustion gases and convert this energy into a useful form (e.g., mechanical work). In the reciprocating piston internal combustion engine application, the additional pressure provided by the decomposition operation 1215 pushes on a piston attached to a crankshaft. The expanding piston volume cools the combustion gases inside the piston cylinder effectively allowing thermal energy to be converted to mechanical energy. Linear movement of the piston is translated into rotational motion of the crankshaft. The crankshaft may be used to turn a generator to make electricity or move a motor vehicle, for example. An exhausting operation 1225 exhausts spent gasses including primarily nitrogen and oxygen molecules. Since nitrous oxide decomposes into two parts nitrogen molecules and one part oxygen molecules and the mixture of nitrous oxide and fuel is mostly nitrogen oxide, the exhaust contains very little carbon oxide components by mass.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. An engine that derives work from decomposition and combustion of a nitrous oxide fuel mixture, wherein the nitrous oxide within the mixture decomposes into a ratio of two-parts nitrogen and one-part oxygen and spent gasses from combustion and decomposition of the nitrous oxide fuel mixture include no more than 0.7 kilograms of carbon oxides per kilowatt-hour of work.

2. The engine of claim 1, wherein the nitrous oxide fuel mixture includes greater than ten parts nitrous oxide for every one part fuel by mass.

3. The engine of claim 1, wherein combustion of the fuel within the nitrous oxide fuel mixture aids in decomposition of the nitrous oxide into the nitrogen and the oxygen.

4. The engine of claim 1, wherein the nitrous oxide to fuel mass ratio is greater than ten parts nitrous oxide to one part fuel.

5. The engine of claim 1, wherein the nitrous oxide to fuel mass ratio is greater than nine parts nitrous oxide to one part fuel.

6. The engine of claim 1, wherein the nitrous oxide to fuel mass ratio is greater than eight parts nitrous oxide to one part fuel.

7. The engine of claim 1, wherein the nitrous oxide to fuel mass ratio is greater than seven parts nitrous oxide to one part fuel.

8. The engine of claim 1, wherein the nitrous oxide to fuel mass ratio is greater than six parts nitrous oxide to one part fuel.

9. The engine of claim 1, wherein the nitrous oxide to fuel mass ratio is greater than five parts nitrous oxide to one part fuel.

10. The engine of claim 1, wherein the nitrous oxide to fuel mass ratio is greater than four parts nitrous oxide to one part fuel.

11. The engine of claim 1 that derives greater than 50% of its power output from decomposition of a nitrous oxide.

12. The engine of claim 1, wherein the fuel is a hydrocarbon.

13. The engine of claim 1, wherein the nitrous oxide fuel mixture further comprises less than thirty parts of water for every one hundred parts of nitrous oxide by mass, wherein the water reduces the operating temperature of the engine.

14. The engine of claim 1, wherein the nitrous oxide and the fuel are stored in separate containers and mixed prior to injection into the engine.

15. The engine of claim 1, wherein the nitrous oxide and the fuel are separately injected into the engine.

16. The engine of claim 1 incorporated into a motor vehicle.

17. The engine of claim 1 incorporated into a power plant for generating rotary shaft work.

18. A nitrous oxide fuel mixture comprising:
greater than nine parts of nitrous oxide for every one part of fuel by mass, wherein the nitrous oxide within the mixture is configured to decompose within an engine to a ratio of two-parts nitrogen and one-part oxygen, and release energy.

19. The nitrous oxide fuel mixture of claim 18, wherein combustion of the fuel and decomposition of the nitrous oxide within the mixture outputs less than 0.7 kilograms of carbon oxides per kilowatt-hour of work.

20. The nitrous oxide fuel mixture of claim 18, wherein combustion of the fuel within the mixture provides a catalyst for decomposition of the nitrous oxide into the nitrogen and the oxygen.

21. The nitrous oxide fuel mixture of claim 18, wherein the fuel is a hydrocarbon.

22. The nitrous oxide fuel mixture of claim 18, further comprising:
less than thirty parts of water for every one hundred parts of nitrous oxide by mass.

23. A method comprising:
supplying a mixture of nitrous oxide and fuel to an engine;
igniting and combusting the fuel within the engine;
decomposing the nitrous oxide within the engine;
extracting work from the decomposing nitrous oxide and combusting fuel; and
exhausting spent gasses including no more than 0.7 kilograms of carbon oxides per kilowatt-hour of work.

24. The method of claim 23, further comprising:
exhausting spent gasses including nitrogen and oxygen molecules.

25. The method of claim 23, wherein the nitrous oxide decomposes into a ratio of two-parts nitrogen and one-part oxygen.

26. The method of claim 23, wherein combustion of the fuel aids in decomposition of the nitrous oxide into the nitrogen and oxygen.

27. The method of claim 23, wherein the fuel is a hydrocarbon.

28. The method of claim 23, wherein the mixture includes more than nine parts nitrous oxide for every one part of fuel by mass.

29. The method of claim 23, wherein the supplying operation includes mixing the nitrous oxide and fuel prior to injection into the engine.

30. The method of claim 23, wherein the supplying operation includes separately injecting the nitrous oxide and the fuel into the engine.
